(19) United States
(12) Patent Application Publication
(10) Pub. No.: US 2025/0310650 A1
(43) Pub. Date: Oct. 2, 2025

(54) FAST OPERATING SYSTEM LOGIN METHOD AND SYSTEM

(71) Applicant: REALTEK SEMICONDUCTOR CORP., HSINCHU (TW)

(72) Inventors: SHI-HAO LI, HSINCHU (TW); PAO-CHI YEH, HSINCHU (TW)

(21) Appl. No.: 19/088,374

(22) Filed: Mar. 24, 2025

(30) Foreign Application Priority Data
Mar. 27, 2024 (TW) 113111316

(51) Int. Cl. H04N 23/71; G06F 21/32; G06T 7/70; G06V 10/141; G06V 10/50; G06V 20/00; G06V 40/16; H04N 23/72; H04N 23/73; H04N 23/74

(52) U.S. Cl. CPC H04N 23/71; G06F 21/32; G06T 7/70; G06V 10/141; G06V 10/507; G06V 20/35; G06V 40/172; H04N 23/72; H04N 23/73; H04N 23/74; G06T 2207/30201

(57) ABSTRACT

A fast operating system login method and a system are provided. A computer system is activated to enter a login procedure of an operating system. The operating system drives an infrared light source of a camera system to be turned on or off. In particular, the infrared light source of the camera system is driven to be turned off at a first time. An infrared camera is driven to photograph a user for generating continuous frames that include dark frames and bright frames. A first dark frame of the continuous frames is therefore obtained. A scene can be determined according to brightness distribution of the first dark frame, thereby obtaining an exposure setting corresponding to the scene. The infrared camera generates a biometric image according to the exposure setting, and the biometric image is referred to for logging in the operating system through a biometric image identification procedure.

### CROSS-REFERENCE TO RELATED PATENT APPLICATION

This application claims the benefit of priority to Taiwan Patent Application No. 113111316, filed on Mar. 27, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method for logging in an operating system, and more particularly to a fast operating system login method and a system that are able to acquire an appropriate exposure setting for a scene predicted based on brightness distribution of frames.

### BACKGROUND OF THE DISCLOSURE

Windows® Hello relates to a biometric recognition technology that is introduced by Microsoft Corporation in 2015 when releasing the Windows®10 operating system. The Windows® Hello login method uses personal biometric features (such as fingerprints, facial features, or iris features) to achieve identity verification, so as to replace a traditional login method with passwords.

Windows® Hello is a convenient and safer tool to log in the Windows® operating system, and the identity verification with facial features is most widely used by the Windows® Hello login method. Windows® Hello requires a user to align his face with a camera or an infrared (IR) depth camera. The operating system then starts to scan the user's face with the camera and recognize the facial features of the user. The facial features are compared with a preset sample for proceeding with a login procedure. In other two login methods, fingerprint identification requires an additional fingerprint reader, and iris identification needs an iris scanner. Even though the iris identification has a lowest false acceptance rate (FAR), the iris identification can still be affected when the user wears glasses or circle contact lenses. It should be noted that the false acceptance rate indicates the probability of a biometric identification system incorrectly identifying an illegal user as a legitimate user.

Even if the facial identification technology used for Windows® Hello is convenient and accurate in most situations, the facial identification still has certain problems. For example, an ambient light may affect the accuracy of facial identification. FIG. 1 shows an example of an auto-exposure convergence curve with various ambient lights.

FIG. 1 is a diagram showing brightness-convergence curves of continuous frames in an auto-exposure procedure for different scenes (such as an outdoor scene, a back-light scene, a front-light scene, and an indoor scene). As indicated by a front-light auto-exposure convergence curve 105, when the user wants to log in an operating system in the front-light scene, sunlight or light from a specific light source may directly illuminate on the face of the user, and is converged to have an appropriate exposure brightness (which can be represented by “Y” (luminance) with a base of 100) at around an eighth frame for completing the login procedure. As indicated by a back-light auto-exposure convergence curve 103, when the user wants to log in the operating system in the back-light scene, the light shines on the camera from the back of the user, and the light causes the user's facial image to be overexposed or underexposed. At this time, most of the user's facial features will be obscured until auto-exposure convergence of the camera is completed. Therefore, the login procedure requires a longer time, and login is successful only after the operating system accurately recognizes the user's facial features.

In the diagram, the back-light auto-exposure convergence curve 103 shows that the login procedure is completed at around a fourteenth frame. Further, as indicated by an outdoor auto-exposure convergence curve 101, auto-exposure convergence time is affected (e.g., the auto-exposure convergence is completed at a ninth frame) due to the inevitable infrared component in the outdoor scene when an IR camera is used to capture images of the user. As indicated by an indoor auto-exposure convergence curve 107, since indoor light is relatively simple and is less affected by infrared light, the auto-exposure convergence can be quickly accomplished. In this example, the auto-exposure convergence curve is shown to be stable at the beginning.

### SUMMARY OF THE DISCLOSURE

In response to the above-referenced technical inadequacies, provided in the present disclosure is a fast operating system login method and a system thereof. The method is applied to a process of logging in a computer system by a biometric identification technology, by which an infrared portion in a specific light source (e.g., an outdoor light source or sunlight) that may affect performance of biometric identification can be effectively excluded. The method is also adapted to a device with lower computing power.

In an aspect of the fast operating system login method, after the computer system is activated, a login procedure of an operating system is initiated. Then, a light source of a camera system is driven to illuminate on a user, and a camera is driven to photograph the user for generating continuous frames. The system relies on brightness distribution of a first dark frame obtained from the continuous frames to determine a scene and obtain an exposure setting corresponding to the scene. A biometric image of the user can be obtained by photographing the user according to the exposure setting. The biometric image is applied to a biometric image identification procedure for logging in the operating system.

Preferably, the light source is an IR light source, and the camera is an infrared (IR) camera. The light source and the camera are included in the camera system that performs an auto-exposure procedure, a scene-prediction procedure, a user-position prediction procedure, and a scene-weight calculation procedure.

Further, after the camera system is activated, the IR light source is driven to be turned on or off. The IR light source is driven to be turned off at a first time, and the IR camera is used for photographing, so as to obtain the continuous frames that include continuous dark frames and bright frames. The first dark frame is obtained from the continuous frames. The scene can be determined based on the brightness distribution of the first dark frame.

In an aspect of a process of determining the scene, the first dark frame is divided into multiple blocks, and brightness statistics is performed on each of the blocks for obtaining brightness statistical values of multiple central blocks and multiple corner blocks. The brightness statistical values of the multiple central blocks and the multiple corner blocks are compared with multiple thresholds measured from actual scenes. Comparison results with respect to the thresholds of various actual scenes are used to predict an outdoor scene, a back-light scene, a front-light scene, and an indoor scene.

Still further, the fast operating system login method also includes a process of predicting a position of the user in the first dark frame for accurately obtaining a facial brightness value of the user. Both the brightness distribution of the first dark frame and the facial brightness value of the user are used to determine the appropriate exposure setting. When the scene is determined as the back-light scene, a position with a lowest brightness statistical value in the first dark frame is the position of the user. When the scene is determined as the front-light scene, a position with a highest brightness statistical value in the first dark frame is the position of the user.

Further, weight values among the blocks can be decided and the exposure setting can be adjusted according to the predicted scene, so as to obtain the biometric image appropriate for the scene and achieve the purpose of fast logging in the operating system.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram showing examples of conventional auto-exposure convergence curves in various scenes with different ambient lights;

FIG. 2 is a schematic diagram depicting a scenario in which a fast operating system login method of the present disclosure is applied;

FIG. 3 is a flowchart illustrating a firmware process of a camera system when operating the fast operating system login method according to one embodiment of the present disclosure;

FIG. 4 is a flowchart illustrating the fast operating system login method according to one embodiment of the present disclosure;

FIG. 5 is a schematic diagram illustrating continuous frames to be generated by the fast operating system login method of the present disclosure;

FIG. 6 is a schematic diagram showing a frame image that is used to predict a scene according to one embodiment of the present disclosure;

FIG. 7 is a flowchart illustrating a process of predicting the scene according to one embodiment of the present disclosure;

FIG. 8(A), FIG. 8(B), FIG. 8(C), FIG. 8(D), FIG. 8(E), and FIG. 8(F) are schematic diagrams showing position shifts of a user;

FIG. 9 is a schematic diagram showing an example of an auto-exposure convergence curve when operating the fast operating system login method according to one embodiment of the present disclosure; and

FIG. 10(A) and FIG. 10(B) are schematic diagrams showing images of the user before and after the fast operating system login method is performed.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

In order to improve an auto-exposure convergence speed when using a biometric image identification technology biometric image to log in an operating system in various scenes with different ambient lights, provided in the present disclosure is a fast operating system login method and a system thereof. According to certain embodiments of the fast operating system login method, the method can use an infrared (IR) camera to capture biometric images (e.g., facial images), and can perform an auto-exposure algorithm, so that a camera system that performs the method can effectively reduce a convergence time for an auto-exposure procedure when using the IR camera in various light sources. There are roughly two types of the light sources, which are front light and back light. Therefore, the user experience can be improved when the speed for logging in the operating system is effectively increased. The above-described operating system refers to any system (e.g., a computer operating system) that can be entered by authenticating a user identity.

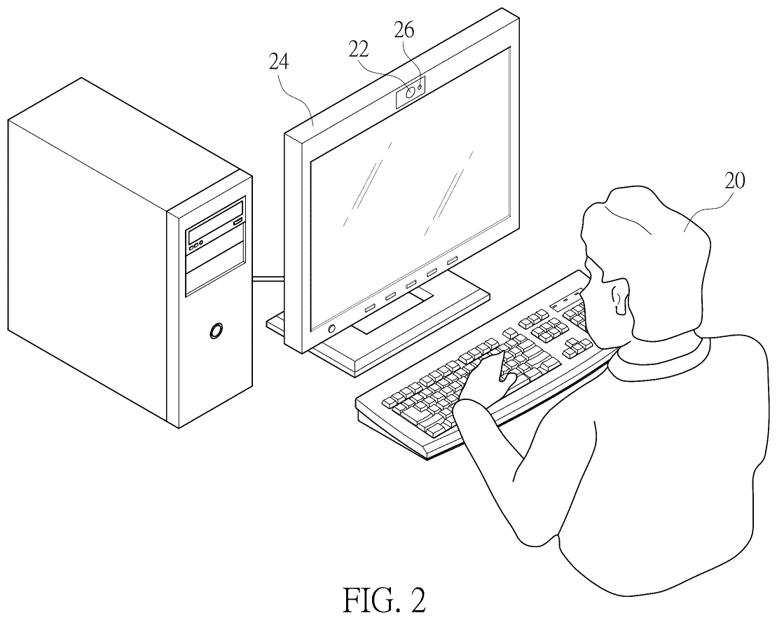

The system applying the fast operating system login method of the present disclosure can be, for example, the computer operating system that applies a facial image recognition technology. Reference is made to FIG. 2, which is a schematic diagram illustrating a scenario in which the fast operating system login method is applied according to one embodiment of the present disclosure.

In the diagram, a computer system 24 operates a computer operating system (OS) that waits for a user 20 to log in after a booting procedure. A light source 26 of a camera system is driven to illuminate the user 20, and a camera 22 of the camera system is driven to capture images and detect if any person is in front of the computer. When the user 20 is detected to be in front of the computer, the computer system 24 immediately initiates a login procedure for the operating system, in which the camera 22 of the camera system is driven to capture images of the face of the user 20. After continuous images are captured, the images are provided for the computer system 24 to proceed with facial image recognition. The user 20 can successfully log in the computer system 24 after his facial image features are compared.

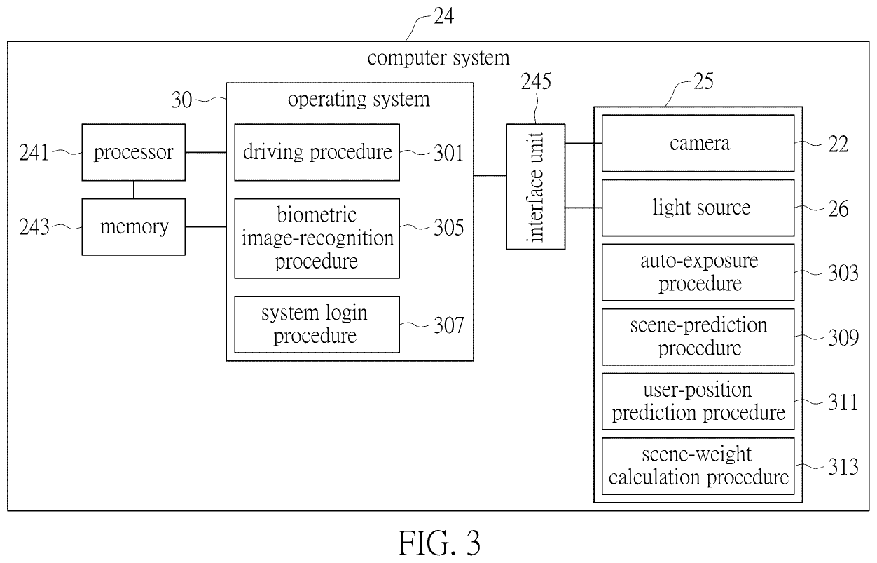

The computer system 24 refers to any system that can be logged on through a biometric identification procedure. Reference is made to FIG. 3.

As shown in FIG. 3, main processing circuits of the computer system 24 include a processor 241 and a memory 243, so as to operate an operating system 30. The computer system 24 includes the operating system 30, a camera system 25 that includes the camera 22 and the light source 26, and an interface unit 245 that interconnects with the operating system 30 and the camera system 25. In one further embodiment of the present disclosure, the camera system 25 can be an external system that connects with the computer system 24 via a specific connection. Main procedures operated in the operating system 30 include a driving procedure 301 that drives the camera 22 and the light source 26 of the camera system 25, a biometric image-recognition procedure 305 that captures biometric images and performs identification, and a login procedure 307.

Further, the camera system 25 operates an auto-exposure procedure 303 that includes a scene-prediction procedure 309, a user-position prediction procedure 311, and a scene-weight calculation procedure 313. An instant scene for logging in the operating system can be obtained through the scene-prediction procedure 309, so as to acquire an exposure setting adapted to the instant scene. The user-position prediction procedure 311 is used to determine whether the user is in a front-light scene or a back-light scene, so that brightness information in the biometric image of the user can be accurately used for acquiring an appropriate exposure setting. Lastly, the scene-weight calculation procedure 313 is used to obtain a weight value corresponding to the instant scene. The weight value is calculated for adaptively obtaining a product of an exposure time and gain.

According to one embodiment of the present disclosure, the camera 22 adopts an IR camera or is accompanied with a color camera for obtaining continuous frames, and the light source 26 is, for example, an IR light source (e.g., an IR LED). The computer system 24 drives the camera system 25 and the light source 26 to be turned on or off through the driving procedure 301. The camera 22 can continuously obtain bright frames and dark frames. It should be noted that, taking the IR light source as an example, the computer system 24 can continuously obtain IR bright frames and IR dark frames. The bright frames contain energy reflected by the infrared light emitting on an object (e.g., the user or his face) and energy received from an external infrared light. The dark frames only contain the energy received from the external infrared light.

When the login procedure 307 (e.g., Windows® Hello) of the operating system 30 receives frame pairs that include the bright frames and the dark frames generated by the IR camera, the operating system 30 also performs subtraction on the bright frames and the dark frames, so as to acquire a subtracted frame that only contains the energy of the infrared light reflected from the object (e.g., the user or his face) when the infrared light illuminates on the user. The subtracted frame allows the operating system 30 to perform the biometric image-recognition procedure 305 for acquiring the features that are compared with the biometric features stored in the memory 243 and pre-registered in the operating system 30. In the login procedure 307, whether or not the instant biometric features of the user (e.g., the user's face) are consistent with the pre-registered biometric features is determined, so as to verify the user who matches the pre-registered biometric features for logging in the computer system 24.

It should be noted that, in addition to the IR camera with an IR photo-sensor, the camera system can also use the color camera to acquire the color images of the biometric features. The color information of the biometric features can be used for other purposes, such as facial anti-spoofing inspection. The facial anti-spoofing inspection is a procedure to be performed after applying the IR camera to identify the biometric features of the user. That is to say, the facial anti-spoofing inspection is performed after the biometric identification procedure is accomplished.

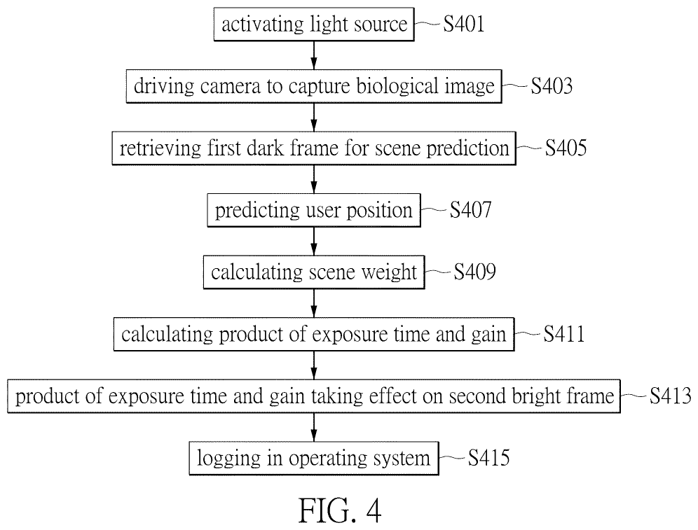

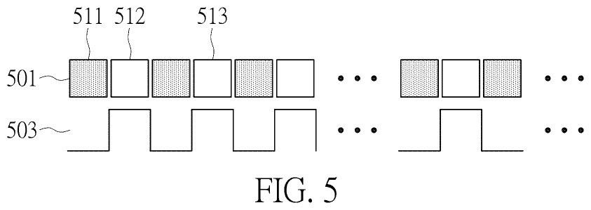

Compared with the conventional biometric identification technology that requires a longer auto-exposure convergence time (since the biometric identification procedure will be affected by the ambient lights), the fast operating system login method of the present disclosure uses the camera to take a first IR dark frame from continuous biometric images, and uses the first IR dark frame as a basis for scene prediction. The image information of the first dark frame is used to predict gain for exposure. Reference is made to FIG. 4, which is a flowchart illustrating the fast operating system login method according to one embodiment of the present disclosure. Reference is also made to FIG. 5, which is a schematic diagram depicting the continuous frames generated in the fast operating system login method.

According to the flowchart shown in FIG. 4, after the computer system is activated, a processing circuit of the camera system performs the fast operating system login method. After peripherals are activated in a booting procedure, the login procedure is initiated. In the login procedure, a driver is used for driving the light source of the camera system to illuminate on the user and controlling the IR light source to be quickly turned on or off (step S401).

Reference is next made to FIG. 5, which is a schematic diagram depicting the continuous frames to be generated in the method according to one embodiment of the present disclosure. When the fast operating system login method is in operation, the computer system drives the IR light source of the camera system to be turned on or off according to a high or a low level of an IR light source driving pulse 503. The camera of the camera system is driven to capture biometric images of the user, so as to form continuous IR frame pairs that include dark frames and bright frames (step S403). The continuous frame pairs include continuously-changed dark frames and bright frames. The continuous IR frames 501 shown in FIG. 5 include continuous IR dark frames and IR bright frames.

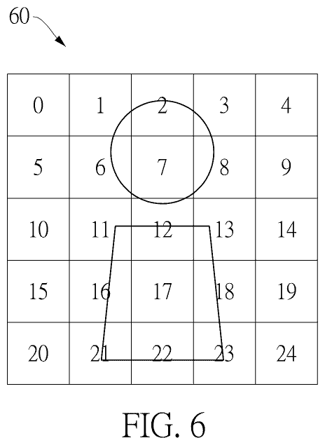

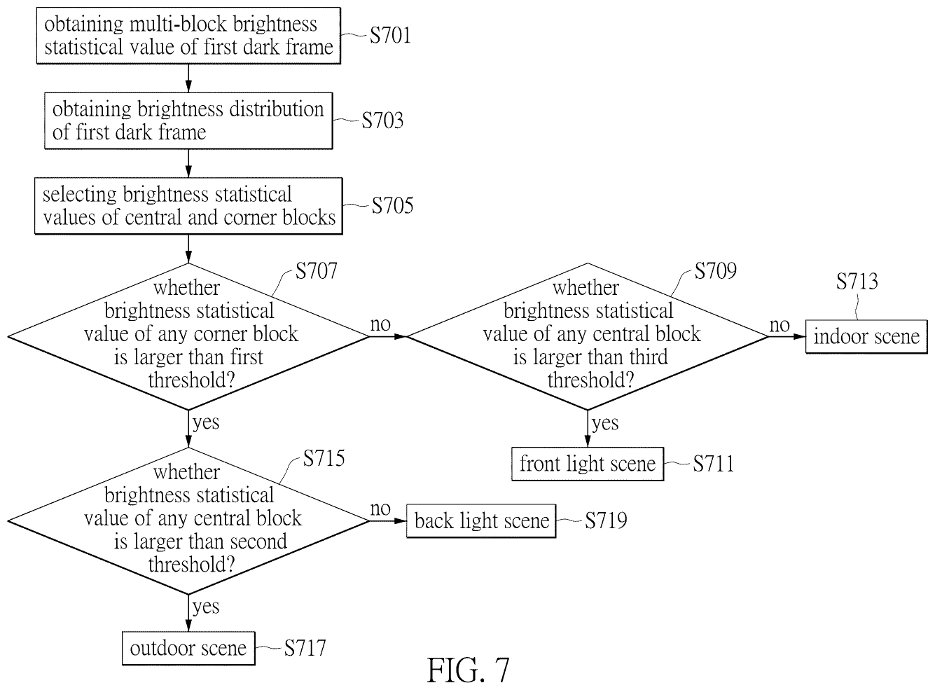

In particular, when both the light source and the camera start to capture images of the user, the light source is driven to be turned off at a first switching time. The camera is driven to capture a first dark frame 511 and then a first bright frame 512, so as to form multiple frame pairs that include dark-bright-dark-bright frames. The first dark frame 511 is particularly used for scene prediction. The scene-prediction procedure is used to identify the scene (step S405), such as a front-light scene, a back-light scene, an indoor scene, or an outdoor scene (but not limited thereto). Next, an exposure setting (such as a product of an exposure time and gain corresponding to the scene) can be obtained. The process of scene prediction can refer to the embodiments shown in FIG. 6, FIG. 7 and equation 1.

However, according to one of the embodiments of the present disclosure, the scene-prediction procedure further includes using a user-position prediction procedure to predict a position of the user when the user is in the front-light scene or the back-light scene (step S407), so as to achieve accurate exposure of the image. One of the objectives to predict the position of the user is to accurately acquire a facial brightness value of the user based on the position of the user. Accordingly, the camera system can rely on both brightness distribution of the first dark frame and the facial brightness value of the user to determine an appropriate exposure setting. When the scene and the position of the user have been predicted, a brightness ratio of the brightness of a corner block and the brightness of a central block of the first dark frame can be further obtained. The brightness ratio can be regarded as a weight value corresponding to the predicted scene (step S409). The weight value is used for adjusting and obtaining a more appropriate exposure setting. The exposure setting to be obtained based on the predicted scene includes a product of the exposure time and the gain. A more appropriate exposure setting can be obtained based on the position of the user, and the exposure time and the gain adapting to the scene can be adjusted based on the weight value. Afterwards, the product (EtGain) of the exposure time and the gain is calculated (step S411). The exposure time and the gain to be calculated based on the brightness information of the first dark frame 511 can take effect on a second bright frame 513 of a second frame pair (step S413). That is to say, the biometric image having an accurate exposure value can be obtained when the operating system receives the second frame pair, so as to proceed with the login procedure for logging in the operating system biometric image (step S415).

According to one embodiment of the fast operating system login method, in addition to using the scene prediction procedure for effectively speeding up the time for logging in the operating system, user position prediction and calculation of scene weights are also used.

### [Scene Prediction]

Implementation of scene prediction in the above-described step S405 is further illustrated below. Reference is made to FIG. 6, which is an example of performing scene prediction based on the first dark frame. Reference is also made to FIG. 7, which is a flowchart illustrating the process of scene prediction.

FIG. 6 shows a first dark frame 60 generated by capturing images of a scene with the camera. The first dark frame 60 can be an IR frame. The first dark frame 60 is divided into multiple blocks (e.g., 5×5=25) based on a size of the image. Brightness statistics is then performed on each of the blocks of the first dark frame 60, and multiple brightness statistical values (e.g., 25 brightness statistical values) are obtained according to a quantity of the blocks (step S701). A certain amount of brightness values (e.g., seven values) are selected from the multiple brightness statistical values, and an average brightness thereof is calculated. This average brightness represents an average brightness of an entire frame.

Equation 1 is used to obtain the brightness distribution of the first dark frame 60, and the brightness distribution includes an average brightness of a corner block and another average brightness of a central block of the first dark frame 60 (step S703). The brightness distribution is used to describe brightness characteristics of the first dark frame 60, in which “I” denotes an infrared image, “Corner” denotes a corner block, “Center” denotes a central block, “UL” denotes an upper-left direction, “UR” denotes an upper-right direction, “DL” denotes a down-left direction, and “DR” denotes a down-right direction.

According to the exemplary example shown in FIG. 6, “Corner UL” represents the upper-left corner blocks (e.g., the blocks 0, 1, 5 and 10) of the first dark frame 60. “Corner UR” represents the upper-right corner block (e.g., the blocks 3, 4, 9 and 14) of the first dark frame 60. “Corner DL” represents the lower-left corner blocks (e.g., the blocks 15 and 20) of the first dark frame 60. “Corner DR” represents the lower-right corner blocks (e.g., the blocks 19 and 24) of the first dark frame 60. “Center” represents the central blocks 7, 12, 17 and 22, “Center L” represents center-left blocks 6, 11, 16 and 21, and “Center R” represents center-right blocks 8, 13, 18 and 23.

$$Corner UL : ( I [ 0 ] + I [ 1 ] + I [ 5 ] + I [ 10 ] ) / 4 ; \qquad Equation 1$$

$$Corner UR : ( I [ 3 ] + I [ 4 ] + I [ 9 ] + I [ 14 ] ) / 4 ;$$

$$Corner DL : ( I [ 15 ] + I [ 20 ] ) / 2 ;$$

$$Corner DR : ( I [ 19 ] + 1 [ 24 ] ) / 2 ;$$

$$Center : ( I [ 7 ] + I [ 12 ] + I [ 17 ] + I [ 22 ] ) / 4 ;$$

$$Center L : ( I [ 6 ] + I [ 11 ] + I [ 16 ] + I [ 21 ] ) / 4 ;$$

$$Center R : ( I [ 8 ] + I [ 13 ] + I [ 18 ] + I [ 23 ] ) / 4.$$

Next, the brightness statistical values of a certain amount (e.g., seven) of central blocks selected from the multiple blocks and the brightness statistical values of the multiple corner blocks are obtained (step S705), and are used to be compared with multiple thresholds measured in an actual scene (such as the outdoor scene, the back-light scene, the front-light scene, and the indoor scene). Referring to FIG. 6, a human shape is shown in a frame. The thresholds are set based on a light distribution of the face of the user and its surroundings in different scenes. The thresholds set in the scene prediction procedure include a first threshold, a second threshold, and a third threshold. The thresholds are set to be different from each other according to the brightness distribution of an entire frame in different scenes. The threshold corresponding to one of the scenes can be a combination of brightness values of multiple blocks to be measured in the scene. A comparison result obtained through comparison with the thresholds corresponding to the various scenes is used to predict whether the scene where the user logs in the operating system is the outdoor scene, the back-light scene, the front-light scene, or the indoor scene.

In the flowchart shown in FIG. 7, after the brightness statistical values of the central blocks and the corner blocks of the first dark frame are obtained, whether or not the brightness statistical value of any of the corner blocks (i.e., the Corner UL, the Corner UR, the Corner DL, or the Corner DR) is larger than the first threshold is determined (step S707). If none of the brightness statistical values of the corner blocks is larger than the first threshold (represented as “no”), whether or not the brightness statistical value of any of the central blocks (i.e., Center, Center L, or Center R) is larger than the third threshold is determined (step S709). If the brightness statistical value of any central block is larger than the third threshold (represented as “yes”), the scene is predicted as the front-light scene (step S711). If none of the brightness statistical values of the central blocks is larger than the third threshold (represented as “no”), the scene is predicted as the indoor scene (step S713).

The process returns to step S707. If the brightness statistical value of any corner block is determined to be larger than the first threshold (represented as “yes”), whether or not the brightness statistical value of any central block (i.e., Center, Center L, or Center R) is larger than the second threshold is determined (step S715). If the brightness statistical value of any central block is larger than the second threshold (represented as “yes”), the scene is predicted as the outdoor scene (step S717). Conversely, if none of the brightness statistical values of the central blocks is larger than the second threshold (represented as “no”), the scene is predicted as the back-light scene (step S719).

In an exemplary example where the brightness statistical values of the blocks of an entire frame are obtained, if the brightness statistical values of both the central blocks and the corner blocks are larger than the thresholds, the entire IR image is indicated to be bright, and the user is determined to be in the outdoor scene. If only the brightness statistical values of the corner blocks are larger than the thresholds, and the brightness statistical values of the central blocks are not larger than the thresholds, the user is determined to face a light source that is in the back-light scene.

### [Prediction of Position of User]

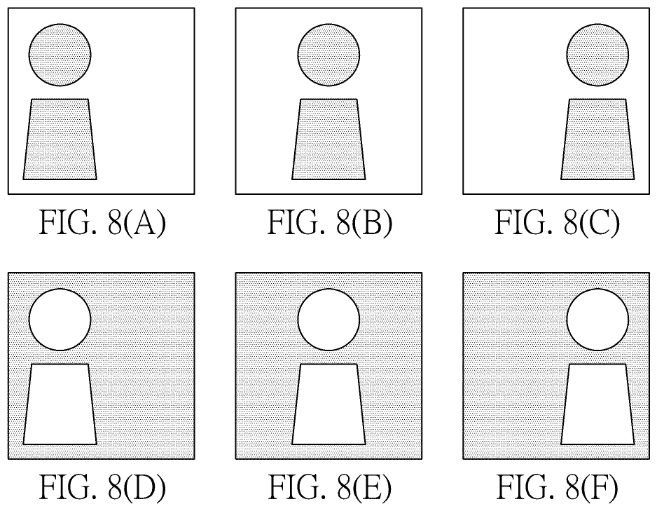

When using the biometric image (e.g., the facial image) to log in the operating system, the operating system requires the user to stay at the position where the system can identify his biometrics. For example, the system may require the user to face toward the camera for facilitating the system to retrieve the biometrics. In practice, the camera is used to capture images of the user, but the user may not always stay at a fixed position since he may shift to a left position or to a right position. Reference is made to FIG. 8(A) to FIG. 8(F), which are schematic diagrams showing position shifts of a user.

In order to predict an appropriate exposure setting by effectively retrieving the brightness information of the biometric image of the user (e.g. the facial image of the user), the fast operating system login method of the present disclosure uses an algorithm to predict the position of the user in the back-light scene or the front-light scene. In this way, whether the position of the user is left, middle, or right can be determined.

According to one of the embodiments of the present disclosure, the algorithm to predict the position of the user can be equation 2 that includes a formula (1) and a formula (2). Here, “P_{backlight}” of formula (1) and “P_{frontlight}” of formula (2) respectively indicate the positions of the user when he is in the back-light scene and the front-light scene. The function “argmin” in equation 2 is used to obtain a smallest variable.

$$\begin{matrix}Equation 2 & \\ {p}_{b acklight} = arg min ( Center\_L , Center , Center\_R ) ; & ( 1 )\end{matrix}$$

$${p}_{frontlight} = arg max ( Center\_L , Center , Center\_R ) . \qquad ( 2 )$$

Taking the facial features as an example, when the scene is determined as the back-light scene, the brightness statistical values of the multiple blocks (i.e., the corner blocks or the central blocks) divided from the dark frame (preferably the first dark frame) of the face of the user are lower, and the function “argmin” is used to obtain the position with a lowest brightness statistical value in the dark frame. Therefore, the actual position of the user can be predicted. As shown in FIG. 8(A), FIG. 8(B), and FIG. 8(C), the user is in the back-light scene. Conversely, when the scene is determined as the front-light scene, the function “argmax” is used to obtain the position with a highest brightness statistical value in the dark frame, and the actual position of the user can also be predicted. As shown in FIG. 8(D), FIG. 8(E), and FIG. 8(F), the user is in the front-light scene.

It should be noted that the algorithm used to predict the position of the user is adapted to the scenario where the user is in the front-light scene or the back-light scene, but is not adapted to the outdoor scene or the indoor scene (the IR dark frame cannot be used to predict the position of the user for being almost all white or almost all black in the outdoor scene or the indoor scene). In the step of predicting the position of the user, since the brightness statistical values of the left, middle, and right positions are close to one another, the middle position can be a default position in one embodiment.

### [Calculation of Scene Weight]

When the scene has been determined or the position of the user has been predicted, a ratio of the brightness statistical values of the corner blocks and the central blocks is referred to for calculating the weight value corresponding to the predicted scene. For example, as shown in equation 3 (which includes formulas (3), (4), (5), and (6)), “W_{backlight}” indicates a weight value for the back-light scene. Taking the back-light scene as an example, since the brightness statistical value of the background in the back-light scene is higher, the brightness statistical value of the face of the user is lower. A ratio between the highest brightness statistical value of the corner blocks and the brightness statistical value of the position of the user is calculated to be the weight value for the back-light scene. Therefore, an intensity value reflecting the back-light scene can be calculated. “W_{frontlight}” in equation 3 is the weight value for the front-light scene. When the scene is determined to be the front-light scene, the brightness statistical value of the face of the user is higher (different from the calculation in the back-light scene). As such, a ratio between the brightness statistical value of the darkest corner block and the brightness statistical value of the position of the user is calculated to be the weight value for the front-light scene. Therefore, an intensity value reflecting the front-light scene is calculated. “W_{outdoor}” in equation 3 indicates the weight value for the outdoor scene. When the scene is determined as the outdoor scene, since the brightness statistical values of the outdoor scene are higher, a ratio between the brightness statistical value of a middle part of the position of the user and a desired brightness statistical value (e.g., a default brightness statistical value set by the system) is calculated to be the weight value for the outdoor scene. “W_{indoor}” in equation 3 indicates the weight value for the indoor scene. When the scene is determined as the indoor scene, since the biometric identification procedure for logging in the operating system is mostly performed in the indoor scene, the product of a preset exposure time and gain is already a best value for the indoor scene. As such, the weight value is set to be “1” without any change.

$$\begin{matrix}Equation 3 & \\ {W}_{backlight} = max ( Corner ) / Ymean ( {P}_{backlight} ) ; & ( 1 )\end{matrix}$$

$${W}_{frontlight} = max ( Corner ) / Ymean ( {P}_{frontlight} ) ; \qquad ( 2 )$$

$${W}_{outdoor} = Center / Ymean Target ; \qquad ( 3 )$$

$${W}_{indoor} = 1. \qquad ( 4 )$$

Afterwards, according to equation 4, the weight value “W*” in equation 3 (which is calculated in response to scene changes) is multiplied by the product of the preset exposure time and the gain of the indoor scene, so as to obtain the product of the exposure time and the gain adapted to the instant scene. As shown in formula (7) of equation 4, the product of the appropriate exposure time and the gain takes effect when the operating system receives the second frame pair generated by the IR camera. This product is multiplied by the weight value corresponding to one of the scenes for obtaining the exposure setting appropriate to the instant scene. A biometric image with an appropriate exposure value can therefore be obtained. The biometric image (e.g., the facial image) is provided for the operating system to identify the user. The speed of the login procedure can be effectively improved.

$$\begin{matrix}Equation 4 & \\ E t G a i {n}_{p r e d i c t} = {W}^{*} \times {EtGain}_{indoor} . & ( 5 )\end{matrix}$$

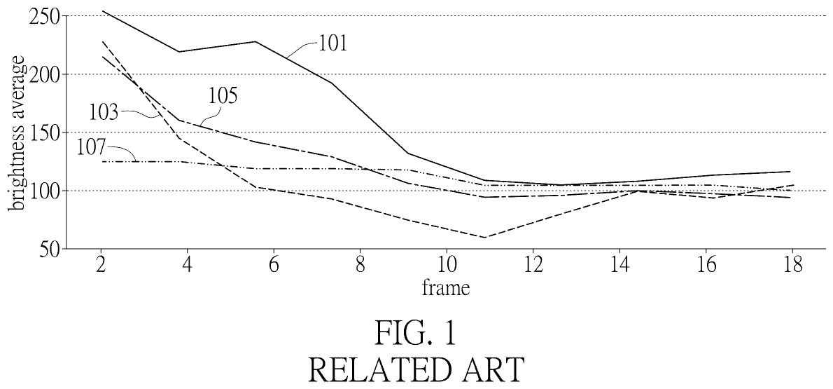

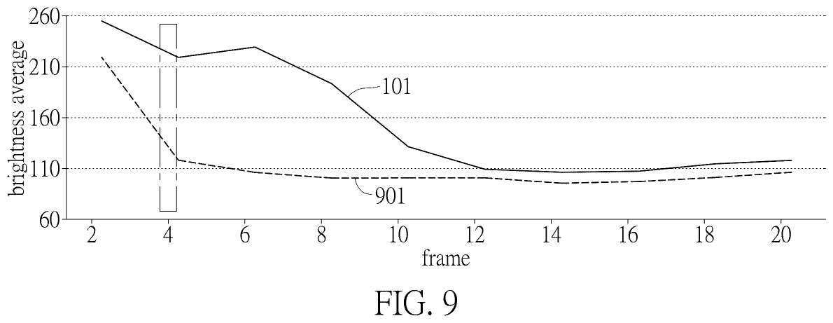

According to the above embodiments of the fast operating system login method, the method allows effective convergence of the time for the auto-exposure procedure when the biometric image of the user is obtained. FIG. 9 shows an auto-exposure convergence curve in the outdoor scene. The curve diagram shows changes of average brightness values when continuous frames are generated in the outdoor scene. The outdoor auto-exposure convergence curve 101 originally shown in FIG. 1 before the fast operating system login method is performed is also drawn in FIG. 9. The outdoor auto-exposure convergence curve 101 shows that the auto-exposure convergence is completed at the tenth frame for obtaining the biometric image available for the system to identify the user. However, the exposure value (i.e., the product of the exposure time and the gain) corresponding to the scene obtained by performing the fast operating system login method can achieve the purpose of quickly obtaining the auto-exposure value. An improved auto-exposure convergence curve 901 is accordingly obtained, by which the login procedure can be accomplished at a fourth frame.

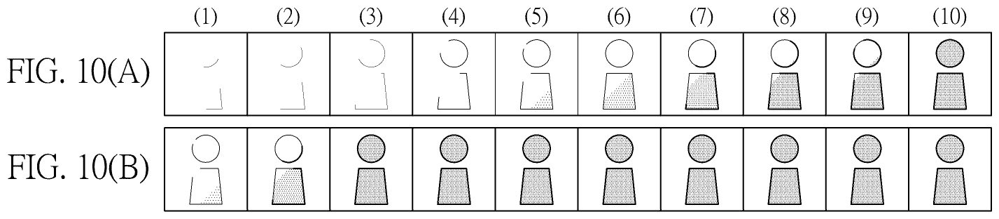

FIG. 10(A) and FIG. 10(B) are schematic diagrams illustrating images of the user to be obtained before and after the fast operating system login method is performed.

FIG. 10(A) shows the continuous frames of the user that are generated before the fast operating system login method is performed. A clearest image is obtained at the tenth frame when the images change gradually from an all-white image to the clearest image through an auto-exposure convergence procedure.

As shown in FIG. 10(B), an appropriate exposure value can be quickly obtained after the fast operating system login method is performed. Therefore, the auto-exposure value can be quickly converged, and the clearest image can be obtained at a third frame. The clearest image can be used as the biometric image for biometric identification.

In conclusion, according to the above embodiments of the fast operating system login method and the system, different from the conventional login procedure that requires a longer time (a frame pair with appropriate brightness cannot be obtained until the auto-exposure convergence of the IR camera is completed), the method of the present disclosure can effectively shorten the auto-exposure convergence time since the first dark frame is used to predict the scene and the exposure setting corresponding to the scene takes effect on the second bright frame. Therefore, the purpose of fast logging in the operating system can be achieved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A fast operating system login method, comprising:
entering a login procedure of an operating system after a computer system is activated;
photographing a user for obtaining continuous frames;
determining a scene according to brightness distribution of a first dark frame of the continuous frames;
obtaining an exposure setting corresponding to the scene;
photographing the user according to the exposure setting, so as to obtain a biometric image of the user; and
performing a biometric image identification procedure on the biometric image for logging in the operating system.

2. The fast operating system login method according to claim 1, wherein the scene is determined by processes of:
dividing the first dark frame into multiple blocks, and performing brightness statistics on each of the blocks;
obtaining brightness statistical values of multiple central blocks and brightness statistical values of multiple corner blocks;
comparing the brightness statistical values of the multiple central blocks and the multiple corner blocks with multiple thresholds measured from actual scenes; and
predicting whether the scene is an outdoor scene, a back-light scene, a front-light scene, or an indoor scene according to a comparison result using the multiple thresholds.

3. The fast operating system login method according to claim 1, wherein, after a camera system is activated, an IR light source is driven to be turned on or off, and an IR camera is used for photographing, so as to acquire the continuous frames that include continuous dark frames and bright frames; wherein the first dark frame of the continuous frames is acquired, and the scene is determined according to the brightness distribution of the first dark frame.

4. The fast operating system login method according to claim 3, wherein, after the IR light source is activated, the IR light source is driven to be turned off at a first time, and the first dark frame is firstly acquired when the IR camera is used for photographing.

5. The fast operating system login method according to claim 4, wherein the scene is determined by processes of:
dividing the first dark frame into multiple blocks, and performing brightness statistics on each of the blocks;
obtaining brightness statistical values of multiple central blocks and brightness statistical values of multiple corner blocks;
comparing the brightness statistical values of the multiple central blocks and the multiple corner blocks with multiple thresholds measured from actual scenes; and
predicting whether the scene is an outdoor scene, a back-light scene, a front-light scene, or an indoor scene according to a comparison result using the multiple thresholds.

6. The fast operating system login method according to claim 5, further comprising: predicting a position of the user in the first dark frame, so as to accurately obtain a facial brightness value of the user and determine the appropriate exposure setting according to the brightness distribution of the first dark frame and the facial brightness value of the user.

7. The fast operating system login method according to claim 6, wherein, in the process of predicting the position of the user in the first dark frame, a position with a lowest brightness statistical value in the first dark frame is regarded as the position of the user when the scene is determined as the back-light scene, or a position with a highest brightness statistical value in the first dark frame is regarded as the position of the user when the scene is determined as the front-light scene.

8. The fast operating system login method according to claim 6, wherein, when the brightness distribution of the first dark frame is used to determine the scene, a brightness ratio between the corner block and the central block of the first dark frame is obtained and used as a weight value for adjusting the exposure setting to be more appropriate.

9. The fast operating system login method according to claim 8, wherein,
when the scene is determined as the back-light scene, a facial brightness statistical value of the user is lower, and a ratio between the brightness statistical value of a brightest one of the corner blocks and a brightness statistical value of the position of the user is calculated and used as the weight value of the scene;
when the scene is determined as the front-light scene, the facial brightness statistical value of the user is higher, and a ratio between the brightness statistical value of a darkest one of the corner blocks and the brightness statistical value of the position of the user is calculated and used as the weight value of the scene;
when the scene is determined as the outdoor scene, a ratio between the brightness statistical value of the position of the user and a preset brightness statistical value is calculated and used as the weight value of the scene;
when the scene is determined as the indoor scene, the weight value of the scene is set to be 1.

10. The fast operating system login method according to claim 9, wherein the exposure setting appropriate for the scene is obtained by calculating a product of an exposure time and a gain that are appropriate for the scene, and then multiplying the product by the weight value of the scene.

11. A system operating a fast operating system login method, comprising:
a computer system, wherein the computer system is externally connected with or includes a camera system, and the camera system includes a camera and a light source;
wherein the computer system operates an operating system that performs the fast operating system login method, and the fast operating system login method includes:
entering a login procedure of the operating system after the computer system is activated;
driving the light source of the camera system to illuminate on a user, and driving the camera of the camera system to photograph the user for obtaining continuous frames;
determining a scene according to brightness distribution of a first dark frame of the continuous frames;
obtaining an exposure setting corresponding to the scene;
photographing the user according to the exposure setting, so as to obtain a biometric image of the user; and
performing a biometric image identification procedure on the biometric image for logging in the operating system.

12. The system according to claim 11, wherein the scene is determined by steps of:
dividing the first dark frame into multiple blocks and performing brightness statistics on each of the blocks;
obtaining multiple brightness statistical values of multiple central blocks and brightness statistical values of multiple corner blocks;
comparing the brightness statistical values of the multiple central blocks and the corner blocks with multiple thresholds measured from actual scenes; and
predicting the scene is an outdoor scene, a back-light scene, a front-light scene or an indoor scene according to a comparison result using the multiple thresholds.

13. The system according to claim 11, wherein the light source is an IR light source, and the camera is an IR camera; wherein the computer system operates the operating system, and a driving procedure is performed to drive the light source and the camera of the camera system to operate; wherein the camera system further performs an auto-exposure procedure that includes a scene-prediction procedure, a user-position prediction procedure, and a scene weight scene-weight calculation procedure.

14. The system according to claim 13, wherein, after the operating system is activated, the IR light source of the camera system is driven to be turned on or off; wherein the IR light source is driven to be turned off at a first time, and the IR camera is used for photographing, so as to obtain the continuous frames that include continuous dark frames and bright frames; wherein the first dark frame of the continuous frames is obtained, and the scene is determined based on the brightness distribution of the first dark frame.

15. The system according to claim 14, wherein the scene is determined by steps of:
dividing the first dark frame into multiple blocks and performing brightness statistics on each of the blocks;
obtaining multiple brightness statistical values of multiple central blocks and brightness statistical values of multiple corner blocks;
comparing the brightness statistical values of the multiple central blocks and the corner blocks with multiple thresholds measured from actual scenes; and
predicting the scene is an outdoor scene, a back-light scene, a front-light scene or an indoor scene according to a comparison result using the multiple thresholds.

16. The system according to claim 15, wherein, in the fast operating system login method, predicting a position of the user in the first dark frame is further included, so as to accurately obtain a facial brightness value of the user and determine the appropriate exposure setting according to the brightness distribution of the first dark frame and the facial brightness value of the user.

17. The system according to claim 16, wherein, in the fast operating system login method, a position with a lowest brightness statistical value in the first dark frame is regarded as the position of the user when the scene is determined as the back-light scene, or a position with a highest brightness statistical value in the first dark frame is regarded as the position of the user when the scene is determined as the front-light scene.

18. The system according to claim 16, wherein, in the fast operating system login method, when the brightness distribution of the first dark frame is used to determine the scene, a brightness ratio between the corner block and the central block of the first dark frame is obtained and is used as a weight value for adjusting the exposure setting to be more appropriate.

19. The system according to claim 18, wherein, in the fast operating system login method,
when the scene is determined as the back-light scene, a facial brightness statistical value of the user is lower, and a ratio between the brightness statistical values of a brightest one of the corner blocks and a brightness statistical value of the position of the user is calculated and used as the weight value of the scene;
when the scene is determined as the front-light scene, the facial brightness statistical value of the user is higher, and a ratio between the brightness statistical value of a darkest one of the corner blocks and the brightness statistical value of the position of the user is calculated and is used as the weight value of the scene;
when the scene is determined as the outdoor scene, a ratio between the brightness statistical value of the position of the user and a preset brightness statistical value is calculated and used as the weight value of the scene;
when the scene is determined as the indoor scene, the weight value of the scene is set to be 1.

20. The system according to claim 19, wherein the exposure setting appropriate for the scene is obtained by calculating a product of an exposure time and a gain that are appropriate for the scene, and then multiplying the product by the weight value of the scene.
